(19) United States
(12) Patent Application Publication
(10) Pub. No.: US 2025/0322338 A1
(43) Pub. Date: Oct. 16, 2025

(54) METHOD AND DEVICE FOR CONSTRUCTING ASSESSMENT INDICATOR SYSTEM FOR TYPICAL MARINE SCENARIOS BASED ON KNOWLEDGE GRAPH, ELECTRONIC DEVICE AND STORAGE MEDIUM

(71) Applicants: Institute of Automation, Chinese Academy of Sciences, Beijing (CN); Fourth Institute of Oceanography, Ministry of Natural Resources (China-ASEAN Countries Joint Resear, Yinhai District (CN); Tianjin University, Nankai District (CN); Qingdao Marine Science and Technology Center, Jimo District (CN)

(72) Inventors: Zhengya Sun, Beijing (CN); Guanhao Fan, Beijing (CN); Qunan Ding, Yinhai District (CN); Anan Liu, Nankai District (CN); Dan Song, Nankai District (CN); Zhiqiang Wei, Jimo District (CN); Jie Nie, Qingdao (CN)

(21) Appl. No.: 19/175,754

(22) Filed: Apr. 10, 2025

(30) Foreign Application Priority Data
Apr. 11, 2024 (CN) 2024104324639

(51) Int. Cl. G06Q 10/0635

(52) U.S. Cl. CPC G06Q 10/0635

(57) ABSTRACT

A method for constructing an assessment indicator system for typical marine scenarios based on a knowledge graph includes: obtaining multi-source data and an initial indicator set; performing knowledge extraction on the data, and constructing a knowledge graph and a spatiotemporal raster database; extending the initial indicator set based on the knowledge graph to obtain a basic indicator set, and obtaining a relationship between basic indicators and a degree of uncertainty of the relationship; establishing a directed weighted network with indicators as nodes based on the relationship and degree of uncertainty of the relationship, and calculating a weight for each basic indicator using a random walk model; and obtaining an observation value of each basic indicator based on the spatiotemporal raster database, determining an assessment value of a comprehensive indicator using the observation value of each basic indicator and the weight for each basic indicator to form an assessment indicator system.

### CROSS-REFERENCE TO RELATED APPLICATIONS

This application claims the benefit of the filing date of Chinese Patent Application Serial No. 2024104324639, filed Apr. 11, 2024, for “METHOD AND DEVICE FOR CONSTRUCTING ASSESSMENT INDICATOR SYSTEM FOR TYPICAL MARINE SCENARIOS BASED ON KNOWLEDGE GRAPH, ELECTRONIC DEVICE AND STORAGE MEDIUM,” the disclosure of which is hereby incorporated herein in its entirety by this reference.

### TECHNICAL FIELD

The present disclosure relates to the field of marine information processing, and, in particular, to a method and a device for constructing an assessment indicator system for typical marine scenarios based on a knowledge graph, an electronic device and a storage medium.

### BACKGROUND

Construction of an assessment indicator system for typical marine scenarios is a complex and critical task, and aims to better understand, analyze and assess sustainable development capabilities and progresses of marine resources, environment and economy, and to provide an important basis for decision-making, management and regulation to protect and improve marine environment, rationally develop marine resources, and promote high-quality development of marine economy.

A traditional assessment indicator system for typical marine scenarios is mainly constructed based on experts' experience, and relies more on personal knowledge and experience. Therefore, there may be subjective bias, which causes limitations of the indicator system. In addition, different experts may have different views, and it is difficult to reach consensus, which affects the consistency of the indicator system.

### BRIEF SUMMARY

The present disclosure provides a method and a device for constructing an assessment indicator system for typical marine scenarios based on a knowledge graph, an electronic device and a storage medium, which solves the defect of the marine indicator system constructed based on experts' experience in the prior art, which has limitations.

The present disclosure provides a method for constructing an assessment indicator system for typical marine scenarios based on a knowledge graph, including:
obtaining multi-source data associated with marine science and an initial indicator set;
performing knowledge extraction on the multi-source data, and constructing a knowledge graph for typical marine scenarios and a spatiotemporal raster database based on a result of the knowledge extraction;
extending the initial indicator set based on the knowledge graph to obtain a basic indicator set, and obtaining a relationship between basic indicators and a degree of uncertainty of the relationship between the basic indicators;
establishing a directed weighted network with indicators as nodes based on the relationship between the basic indicators and the degree of uncertainty of the relationship between the basic indicators, and calculating a weight for each basic indicator using a random walk model; and
obtaining an observation value of each basic indicator based on the spatiotemporal raster database, determining an assessment value of a comprehensive indicator using the observation value of each basic indicator and the weight for each basic indicator to form an assessment indicator system for typical marine scenarios.

According to the method for constructing the assessment indicator system for typical marine scenarios based on the knowledge graph, obtaining the relationship between the basic indicators and the degree of uncertainty of the relationship between the basic indicators includes:
extracting an initial indicator relationship between the basic indicators from the knowledge graph for typical marine scenarios; and
performing standardized transformation on the initial indicator relationship to obtain the relationship between the basic indicators and the degree of uncertainty of the relationship between the basic indicators.

According to the method for constructing the assessment indicator system for typical marine scenarios based on the knowledge graph, establishing the directed weighted network with indicators as nodes based on the relationship between the basic indicators and the degree of uncertainty of the relationship between the basic indicators, and calculating the weight for each basic indicator using the random walk model includes:
obtaining an initial weight for each basic indicator as an initial weight for a node of the directed weighted network;
determining a number of times of effective impact between the basic indicators based on the relationship between the basic indicators and the degree of uncertainty of the relationship between the basic indicators, and determining the number of times of effective impact as an initial weight for an edge of the directed weighted network; and
performing iterative calculation on the initial weight for the node until convergence using the random walk model based on the initial weight for the node and the initial weight for the edge of the directed weighted network, to obtain the weight for each basic indicator.

According to the method for constructing the assessment indicator system for typical marine scenarios based on the knowledge graph, performing iterative calculation on the initial weight for the node until convergence using the random walk model based on the initial weight for the node and the initial weight for the edge of the directed weighted network to obtain the weight for each basic indicator includes:

performing iterative calculation on the initial weight for the node based on the following formula until convergence to obtain the weight for each basic indicator:

$$I ( x ) = \frac{1 - d}{N} + d {\sum }_{y ∈ R ( x )} I ( y ) \cdot {W}_{( x , y )}$$

$${W}_{( x , y )} = \frac{{n}_{( x , y )}}{N ( y )}$$

$${n}_{( x , y )} = AGG ( \{ {P}_{( x , y )}^{i} , i ∈ M \} )$$

$$N ( y ) = {\sum }_{z ∈ Z ( y )} AGG ( \{ {P}_{( z , y )}^{i} , i ∈ M \} )$$

where I(x), I(y) represent iterative indicator weight values of x and y indicators, respectively; d is a damping factor (0<d≤1), that is, a probability that any indicator is impacted by other indicators; N is a quantity of all basic indicators; R (x) represents a basic indicator set impacted by x indicator; n_{(x,y)} represents a number of times of effective impact of the x indicator on the y indicator, Z(y) represents a set of basic indicators that impact the y indicator, N(y) represents a total number of times of effective impact of all basic indicators on the y indicator, P_{(x,y)}ⁱ represents a quantized value of a degree of uncertainty of the relationship between the x indicator and the y indicator extracted from a literature i, and M represents a total quantity of literatures.

According to the method for constructing the assessment indicator system for typical marine scenarios based on the knowledge graph, obtaining the initial weight for each basic indicator includes:
determining the initial weight for each basic indicator based on the quantity of literatures associated with each basic indicator.

According to the method for constructing the assessment indicator system for typical marine scenarios based on the knowledge graph, performing knowledge extraction on the multi-source data, and constructing the knowledge graph for typical marine scenarios and the spatiotemporal raster database based on the result of knowledge extraction includes:
performing knowledge extraction on the multi-source data based on a data type of the multi-source data, and constructing the knowledge graph for typical marine scenarios based on N-tuple knowledge extracted, where N is a positive integer greater than or equal to 3; and
constructing the spatiotemporal raster database based on spatiotemporal raster data extracted from the multi-source data.

According to the method for constructing the assessment indicator system for typical marine scenarios based on the knowledge graph, extending the initial indicator set based on the knowledge graph to obtain the basic indicator set includes:
searching and matching an initial indicator entity in the knowledge graph, and returning an indicator having an associated or causal relationship with the initial indicator entity; and
supplementing the indicator having the associated or causal relationship to the initial indicator set to obtain the basic indicator set.

The present disclosure further provides a device for constructing an assessment indicator system for typical marine scenarios based on a knowledge graph, including:
a data obtaining unit, used for obtaining multi-source data associated with marine science, and an initial indicator set;
a knowledge extracting unit, used for performing knowledge extraction on the multi-source data, and constructing a knowledge graph for typical marine scenarios and a spatiotemporal raster database based on a result of knowledge extraction;
an indicator extending unit, used for extending the initial indicator set based on the knowledge graph to obtain a basic indicator set, and obtaining a relationship between basic indicators and a degree of uncertainty of the relationship between the basic indicators;
a weight calculating unit, used for establishing a directed weighted network with indicators as nodes based on the relationship between the basic indicators and the degree of uncertainty of the relationship between the basic indicators, and calculating a weight for each basic indicator using a random walk model; and
a system constructing unit, used for obtaining an observation value of each basic indicator based on the spatiotemporal raster database, determining an assessment value of a comprehensive indicator using the observation value of each basic indicator and the weight for each basic indicator, and forming the assessment indicator system for typical marine scenarios.

The present disclosure further provides an electronic device, including a memory, a processor, and a computer program stored on the memory and executable on the processor, where the processor implements any of the methods for constructing the assessment indicator system for typical marine scenarios based on the knowledge graph as described above when executing the program.

The present disclosure further provides a non-transitory computer-readable storage medium storing a computer program, where the computer program, when executed by a processor, implements any of the methods for constructing the assessment indicator system for typical marine scenarios based on the knowledge graph as described above.

The present disclosure further provides a computer program product storing a computer program, where the computer program, when executed by a processor, implements any of the methods for constructing the assessment indicator system for typical marine scenarios based on the knowledge graph as described above.

In the method and the device for constructing an assessment indicator system for typical marine scenarios based on the knowledge graph, the electronic device and the storage medium provided by the present disclosure, the assessment indicator system for typical marine scenarios is formed by obtaining multi-source data associated with marine science and an initial indicator set; performing knowledge extraction on the multi-source data, and constructing a knowledge graph for typical marine scenarios and a spatiotemporal raster database based on a result of knowledge extraction; extending the initial indicator set based on the knowledge graph to obtain a basic indicator set, and obtaining a relationship between basic indicators and a degree of uncertainty of the relationship between the basic indicators; establishing a directed weighted network with indicators as nodes based on the relationship between the basic indicators and the degree of uncertainty of the relationship between the basic indicators, and calculating a weight for each basic indicator using a random walk model; and obtaining an observation value of each basic indicator based on the spatiotemporal raster database, and determining an assessment value of a comprehensive indicator using the observation value of each basic indicator and the weight for each basic indicator. In this way, an objective, comprehensive and highly versatile indicator system may be constructed, and the indicator system constructed may be used to analyze and assess sustainable development capabilities and progresses of marine resources, environment and economy, and provide strong support for the decision-making, management and regulation of subsequent marine development.

### BRIEF DESCRIPTION OF THE DRAWINGS

To illustrate solutions disclosed in the embodiments of the present disclosure or the prior art more clearly, drawings needed in the descriptions of the embodiments or the prior art will be briefly described below. The drawings in the following description are only some of the embodiments of the present disclosure, and other drawings may be obtained based on these drawings without any creative effort for those skilled in the art.

FIG. 1 is a first schematic flow chart of a method for constructing an assessment indicator system for typical marine scenarios based on a knowledge graph according to the present disclosure;

FIG. 2 is a second schematic flow chart of a method for constructing an assessment indicator system for typical marine scenarios based on a knowledge graph according to the present disclosure;

FIG. 3 is a schematic flow chart of a method for determining a weight for each basic indicator according to the present disclosure;

FIG. 4 is a schematic structural diagram of a device for constructing an assessment indicator system for typical marine scenarios based on a knowledge graph according to the present disclosure; and

FIG. 5 is a schematic structural diagram of an electronic device according to the present disclosure.

### DETAILED DESCRIPTION

To illustrate objectives, solutions and advantages of the present disclosure clearly, the solutions in the embodiments of the present disclosure will be described clearly and completely in conjunction with the accompanying drawings in the present disclosure. The described embodiments are part of the embodiments of the present disclosure, rather than all of the embodiments. All other embodiments obtained by those skilled in the art based on the embodiments of the present disclosure without any creative work belong to the scope of the present disclosure.

A traditional assessment indicator system for typical marine scenarios is mainly constructed based on experts' experience, and there are mainly the following defects:
1) Strong subjectivity: experts' experience is based on their personal knowledge and insights, and there may be subjective bias, which causes the constructed indicator system being not objective and comprehensive enough. In addition, different experts may have different views, and it is difficult to reach consensus, which affects the consistency of the indicator system.
2) Limited knowledge update: experts' experience is often limited by their personal knowledge and experience, and may not be able to reflect the latest research results and technological developments in a timely manner. This may cause the constructed indicator system being too old and not in line with reality.

In addition, due to complexity and diversity of marine environment, the indicator system obtained based on experts' experience and field research is only applicable to specific scenarios or local areas, and has poor applicability in other typical scenarios.

In view of the problems that the assessment indicator system of typical marine scenarios constructed based on experts' experience is not objective and comprehensive enough and has poor applicability, an inventive concept of the present disclosure is forming the assessment indicator system for typical marine scenarios by obtaining multi-source data associated with marine science and an initial indicator set; performing knowledge extraction on the multi-source data, and constructing a knowledge graph for typical marine scenarios and a spatiotemporal raster database based on a result of knowledge extraction; extending the initial indicator set based on the knowledge graph to obtain a basic indicator set, and obtaining a relationship between basic indicators and a degree of uncertainty of the relationship between the basic indicators; establishing a directed weighted network with indicators as nodes based on the relationship between the basic indicators and the degree of uncertainty of the relationship between the basic indicators, and calculating a weight for each basic indicator using a random walk model; and obtaining an observation value of each basic indicator based on the spatiotemporal raster database, and determining an assessment value of a comprehensive indicator using the observation value of each basic indicator and the weight for each basic indicator.

Based on the above inventive concept, the present disclosure provides a method and a device for constructing an assessment indicator system for typical marine scenarios based on the knowledge graph, an electronic device and a storage medium, which may be used for the construction of an indicator system for typical marine scenarios to construct an objective, comprehensive and highly applicable indicator system. The indicator system constructed in this way may be used to assess and predict the marine environment, provide support for subsequent marine scientific research, and thus better protect the marine ecological environment.

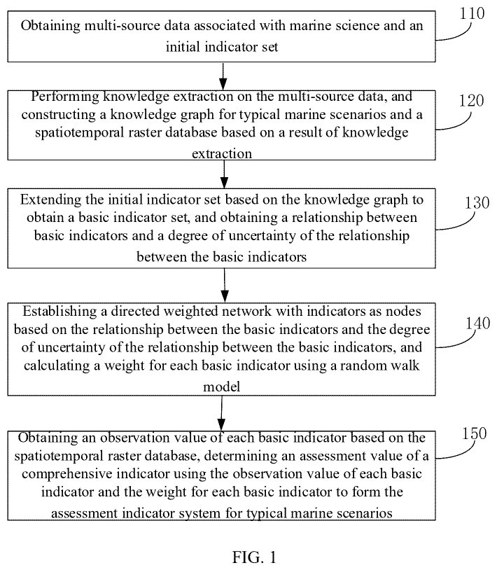

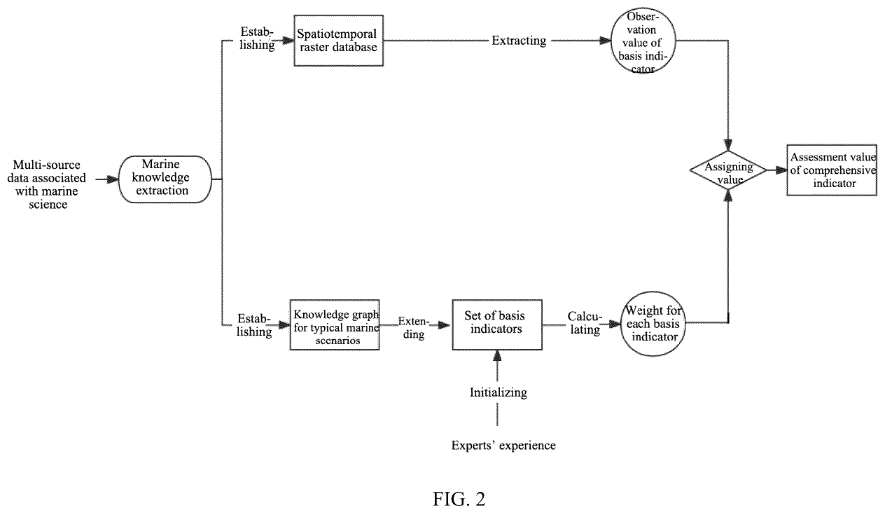

Solutions of the present disclosure will be described in detail below in conjunction with the accompanying drawings. FIG. 1 is a first schematic flow chart of a method for constructing an assessment indicator system for typical marine scenarios based on a knowledge graph according to the present disclosure and FIG. 2 is a second schematic flow chart of a method for constructing an assessment indicator system for typical marine scenarios based on a knowledge graph according to the present disclosure. Each step in the methods may be performed by a device for constructing a marine indicator system. The device may be implemented by software and/or hardware and may be integrated in an electronic device. The electronic device may be a terminal device (such as a smart phone, a personal computer, etc.), or a server (such as a local server or a cloud server, or a server cluster, etc.), or may also be a processor or a chip, etc. As shown in FIG. 1, the method includes the following steps:
step 110: obtaining multi-source data associated with marine science and an initial indicator set.

Specifically, the multi-source data associated with marine science may include online literatures and marine standards collected from web pages. It may also include policies and regulations, professional books, etc. obtained from associated professional websites. It may also include marine survey observation data obtained from professional databases, etc. For example, multi-source data may be obtained from mangrove-associated literatures, marine laws and regulations, marine terminology standard documents, global biodiversity databases, marine survey observation databases, encyclopedia entries, etc.

The multi-source data may be data including multiple modes, such as text, audio, image, signal, and video. The multi-source data obtained may be further pre-processed by screening and cleaning, and performing format conversion, image recognition, signal recognition and like operations to improve data quality.

Here, the initial indicator set may be obtained based on experts' experience. For example, a set of initial indicator structure for “sustainable development of mangroves” may be created based on experts' experience. The secondary indicator “health status” in the initial indicator structure may be further decomposed into 8 tertiary indicators, namely “degree of naturalness,” “ecological sequence integrity,” “canopy density,” “biodiversity,” “wetland degradation rate,” “seawall construction rate,” “invasion area of alien species” and “area affected by diseases and insect pests.”
Step 120: performing knowledge extraction on the multi-source data, and constructing a knowledge graph for typical marine scenarios and a spatiotemporal raster database based on a result of knowledge extraction.

In view of the problem that the initial indicators constructed solely based on experts' experience are not comprehensive and objective, in the present embodiment, graph network models have been widely used in various fields, including marine research, with the development of knowledge graph theory in recent years. Therefore, a knowledge graph for typical marine scenarios and a spatiotemporal raster database may be constructed first. The knowledge graph for typical marine scenarios constructed contains a large amount of objective and authoritative marine knowledge and may be used to enrich the structure of the initial indicator system.

The knowledge graph for typical marine scenarios and the spatiotemporal raster database may be implemented by performing knowledge extraction on the multi-source data. In some embodiments, step 120 specifically includes:
step 121: performing knowledge extraction on the multi-source data based on a data type of the multi-source data, and constructing the knowledge graph for typical marine scenarios based on N-tuple knowledge extracted, where N is a positive integer greater than or equal to 3; and
step 122: constructing the spatiotemporal raster database based on spatiotemporal raster data extracted from the multi-source data.

Specifically, considering the different data types of multi-source data, knowledge extraction may be implemented by a knowledge unit extraction technology corresponding to the data type. For example, for text data, N-tuple knowledge may be extracted by using entity recognition, relationship extraction, attribute extraction and other technologies in combination with large language models. For spatiotemporal data such as marine observation data, spatiotemporal knowledge may be extracted using an extraction algorithm based on a spatiotemporal rule.

Here, the N-tuple knowledge may be extracted through a pre-constructed knowledge extraction model. Sentences with high frequency of occurrence are pre-selected and labelled in the form of (entity, relationship, entity, uncertainty). A knowledge extraction algorithm based on a large language model is constructed, the labeled data is fine-tuned and trained to obtain a knowledge extraction model.

It should be noted that the N-tuple knowledge extracted may be, for example, a quadruple, which may be specifically expressed in the form of (entity, relationship, entity, uncertainty). The entity therein may be understood as each marine indicator; the relationship is the relationship between marine indicators, such as strengthening, impacting, threatening, causing, etc.; the uncertainty may characterize a degree of uncertainty in the relationship between marine indicators, such as obvious, serious, extremely large, etc.

For example, an ERNIE-UIE knowledge extraction model may be constructed using an ERNIE 3.0 large model with 10 billion parameters as a base in combination with the unified framework for universal information extraction (UIE). Taking the sentence “The invasion of alien species has seriously impacted our country's biodiversity resources,” as an example, the N-tuple knowledge extracted is: (invasion of alien species, impact, our country's biodiversity resources, serious). For example, for spatiotemporal data such as marine observation data, an extraction algorithm based on a spatiotemporal rule is used. In the present embodiment, taking the data “On Jul. 28, 2023, Typhoon ‘Dusurui’ landed in City B, Province A,” as an example, the spatiotemporal knowledge extracted is: (time, “20230728”), (space, (Latitude 24° 30′ 44″−24° 54′ 21″ North, Longitude 118° 24′ 56″−118° 41′ 10″ East)).

Then, the N-tuple knowledge extracted is saved in a unified file format and stored in a graph database to construct a knowledge graph for typical marine scenarios.

For marine observation data in multi-source data, the time, space, and measurement parameter values in the data are automatically obtained and stored in a relational database to construct a spatiotemporal raster database.

In addition, multi-source data that is well structured may be aligned and fused with the extracted data to improve the accuracy of the data.
Step 130: extending the initial indicator set based on the knowledge graph to obtain a basic indicator set, and obtaining a relationship between basic indicators and a degree of uncertainty of the relationship between the basic indicators.

Specifically, considering that the knowledge graph for typical marine scenarios constructed based on the collected multi-source data contains a large amount of objective and authoritative marine knowledge, and that the initial indicators constructed based on experts' experience are usually not comprehensive enough, the initial indicator set may be extended based on the knowledge graph to obtain the basic indicator set. For example, the marine indicators that have a specific relationship with the initial indicators in the knowledge graph but are not included in the initial indicator set are added to the initial indicator set to extend the initial indicator set.

In some embodiments, step 130 includes:
step 131: searching and matching an initial indicator entity in the knowledge graph, and returning an indicator having an associated or causal relationship with the initial indicator entity; and
step 132: supplementing the indicator having the associated or causal relationship to the initial indicator set to obtain the basic indicator set.

Specifically, an initial indicator may be input into the knowledge graph, to search and match with the initial indicator entity in the knowledge graph, the initial indicator entity here may be an indicator name in the initial indicator set, and an indicator having an associated or causal relationship with the initial indicator entity is returned.

For example, “biodiversity” indicator is an initial indicator entity, and it is searched and matched in the knowledge graph to return the indicator having an associated or causal relationship with the “biodiversity” indicator, that is, “regional water temperature.” The associated relationship here means that there is a bidirectional impact relationship between any two indicators, such as a positive relationship between each other. The causal relationship means that there is a unidirectional causal relationship between any two indicators.

Further, the number of times of occurrence of the associated or causal relationship may be compared with a given number threshold, or the number may be sorted in a descending order, to screen and return the indicators having the associated or causal relationship with the initial indicator entity.

Subsequently, the indicator having the associated or causal relationship is supplemented to the initial indicator set immediately to obtain the basic indicator set. For example, the indicator “regional water temperature” is supplemented to the initial indicator set. The basic indicator set obtained after supplementation may be more objective and comprehensive in assessing the marine environment from the perspective of “biodiversity” indicator compared to the initial indicator set.

In the method provided by the embodiment of the present disclosure, a knowledge graph for typical marine scenarios is constructed, rich interactive relationships between indicators are obtained based on the semantic associations between indicators in the knowledge graph, and the structure of the initial indicator system is improved from the perspective of marine big data, thereby obtaining a more comprehensive and objective basic indicator system.

The relationship between basic indicators and the degree of uncertainty of the relationship between the basic indicators are obtained after the basic indicator set is obtained. The relationship between basic indicators may be an entity relationship between entities corresponding to basic indicators in the knowledge graph. The uncertainty of the relationship between basic indicators represents a degree of uncertainty of the entity relationship, and the uncertainty may be represented by a quantified weight.

In some embodiments, obtaining the relationship between the basic indicators and the degree of uncertainty of the relationship between the basic indicators includes:
extracting an initial indicator relationship between the basic indicators from the knowledge graph for typical marine scenarios; and performing standardized transformation on the initial indicator relationship to obtain the relationship between the basic indicators and the degree of uncertainty of the relationship between the basic indicators.

Specifically, the associated or causal relationship between the basic indicators may be extracted from the knowledge graph using an extraction algorithm adapted to the graph database. For example, the initial indicator relationship may be expressed as (temperature rise, strengthening, activity of soil microbes, obvious), (human activities, impacting, area of mangroves, extremely large), (weather disasters, threatening, sustainable development of cities, serious), (coastal erosion, causing, coastal land loss), etc.

Further, standardized transformation may be performed on the initial indicator relationship, and the standardized transformation here may be transformation by homogenization including uniformly expressing the associated or causal relationship between indicators as (entity, impact, entity, uncertainty), and establishing a directed weighted network between indicators.

Uncertainty may characterize the degree of uncertainty of the relationship between indicators, and may be measured by a weight. For example, the weight for “serious” may be set to 0.9, and the weight for “not significant” may be set to 0.1, etc. Furthermore, uncertainty may be looked up in a pre-established dictionary of “uncertainty-weight” reference table, and transformed into a specific weight.
Step 140: establishing a directed weighted network with indicators as nodes based on the relationship between the basic indicators and the degree of uncertainty of the relationship between the basic indicators, and calculating a weight for each basic indicator using a random walk model.

Specifically, a weight for each basic indicator needs to be determined after the basic indicator set is obtained. The associated or causal relationship between the basic indicators is obtained based on the knowledge graph for typical marine scenarios, a process for calculating an indicator weight is modeled as a probability calculation problem based on a random walk graph network, and more objective and authoritative indicator weight is obtained through iterative calculation.

The process for calculating the indicator weight is modeled as a probability calculation model based on random walk graph network. Step 140 may include:
step 141: obtaining an initial weight for each basic indicator as an initial weight for a node of the directed weighted network;
step 142: determining a number of times of effective impact between the basic indicators based on the relationship between the basic indicators and the degree of uncertainty of the relationship between the basic indicators, and determining the number of times of effective impact as an initial weight for an edge of the directed weighted network; and
step 143: performing iterative calculation on the initial weight for the node until convergence using the random walk model based on the initial weight for the node and the initial weight for the edge of the directed weighted network to obtain the weight for each basic indicator.

Specifically, an initial weight for each basic indicator is firstly obtained. The initial weight may be determined based on a quantity of literatures associated with the basic indicator. The quantity of literatures associated with each basic indicator in a network document library is counted, normalized, and used as an initial weight of a corresponding indicator, i.e., an initial weight for a node of the directed weighted network.

Here, a weight of the relationship between indicators may be directly transformed into a number of times of effective impact between basic indicators, and the number of times of effective impact between basic indicators is used as an initial weight for each edge in a directed weighted network. Taking (invasion of alien species, impact, our country's biodiversity resources, serious) and (alien invasion, destruction, regional biodiversity, strong) extracted from the literatures as examples, both the weights of “serious” and “strong” are set to 0.9, then the above knowledge indicates that an aggregate weight of the “alien invasion” indicator on the “biodiversity” indicator is (0.9+0.9)/2, i.e., 0.9, which is transformed into the number of times of effective impact being 9. Taking (damage of diseases and insect pests, impact, canopy density, not significant) and (spread of diseases and insect pests, impact, plant canopy density, certain) as examples, the weight for “not significant” is set to 0.1, and the weight for “certain” is set to 0.5, then the above knowledge indicates that the aggregate weight of the “damage of diseases and insect pests” indicator on the “biodiversity” indicator is (0.1+0.5)/2, i.e., 0.3, which is transformed into the number of times of effective impact being 3.

On this basis, the directed weighted network of each indicator is obtained. For example, for the “biodiversity” indicator, the indicators with associated or causal relationship are “degree of naturalness,” “alien invasion” and “damage of diseases and insect pests,” respectively.

The directed weighted network may be expressed as: ‘biodiversity (0.6388)’: [‘degree of naturalness’] *5+ [‘alien invasion’] *9+ [‘damage of diseases and insect pests’] *3, which means that the “biodiversity” indicator is effectively impacted by the “degree of naturalness” indicator 5 times, effectively impacted by the “alien invasion” indicator 9 times, and effectively impacted by the “damage of diseases and insect pests” indicator 3 times, and means that the initial indicator weight of the “biodiversity” indicator is 0.6388. In addition, the initial indicator weights of the three indicators (degree of naturalness, alien invasion, and damage of diseases and insect pests) are (0.1417, 0.1419, 0.0352) based on statistics.

Then, iterative calculation is performed on the initial weight for the node using a random walk model until convergence to obtain the weight for each basic indicator.

In some embodiments, iterative calculation is performed on the initial weight for the node based on the following formula until convergence to obtain the weight for each basic indicator:

$$I ( x ) = \frac{1 - d}{N} + d {\sum }_{y ∈ R ( x )} I ( y ) \cdot {W}_{( x , y )}$$

$${W}_{( x , y )} = \frac{{n}_{( x , y )}}{N ( y )}$$

$${n}_{( x , y )} = AGG ( \{ {P}_{( x , y )}^{i} , i ∈ M \} )$$

$$N ( y ) = {\sum }_{z ∈ Z ( y )} AGG ( \{ {P}_{( z , y )}^{i} , i ∈ M \} )$$

where I(x), I(y) represent iterative indicator weight values of x and y indicators, respectively; d is a damping factor (0<d≤1), that is, a probability that any indicator is impacted by other indicators; N is a quantity of all basic indicators; R(x) represents a basic indicator set impacted by x indicator; n_{(x,y)} represents a number of times of effective impact of the x indicator on the y indicator, Z(y) represents a set of basic indicators that impact the y indicator, N(y) represents a total number of times of effective impact of all basic indicators on the y indicator, P_{(x,y)}ⁱ represents a quantized value of a degree of uncertainty of the relationship between the x indicator and the y indicator extracted from a literature i, and M represents a total quantity of literatures.

The above formula may be understood as a probability calculation formula of weights for marine indicators. A calculation principle of this formula is: “the higher the probability, the more indicators are impacted.” In the present embodiment, the damping factor d is set to 0.85 to prevent the occurrence of extreme values of indicator weights in iterative calculation.

Taking the above biodiversity (0.6388)′: [‘degree of naturalness’] *5+ [‘alien invasion’] *9+ [‘diseases and insect pests’] *3 as an example, the following may be obtained:

$$I ( x ) = \frac{1 - d}{N} + d {\sum }_{y ∈ R ( x )} I ( y ) \cdot {W}_{( x , y )} = \frac{1 - 0.85}{3} + 0.85 * ( 0.1417 * \frac{5}{5 + 9 + 3} + 0.1419 * \frac{9}{5 + 9 + 3} + 0.0 \; 352 * \frac{3}{5 + 9 + 3} )$$

the result of the first iteration is: I(x)=0.1546

Iterative calculation is performed until I(x) gradually converges, and a final weight value for the “biodiversity” indicator may be obtained. By the indicator weight calculation method, an indicator system for the sustainable development of mangroves is optimized based on the knowledge graph, and a new indicator system containing the semantic information of the knowledge graph is obtained.

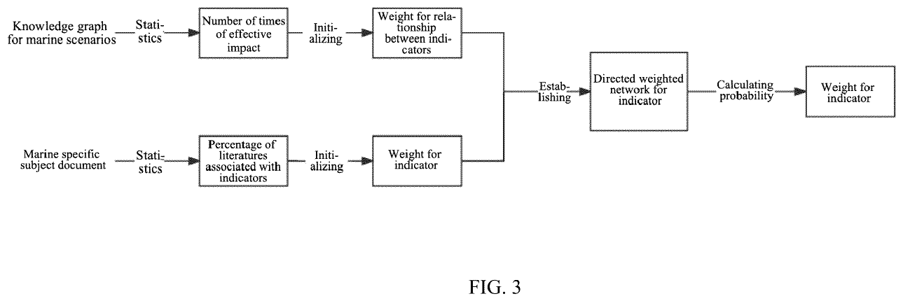

FIG. 3 is a schematic flow chart of a method for determining a weight for each basic indicator according to the present disclosure. As shown in FIG. 3, the method for determining the weight for each basic indicator includes:
determining a number of times of effective impact between the basic indicators based on the degree of uncertainty of the relationship between the basic indicators, and determining a weight for a relationship between indicators, i.e., an initial weight for an edge of the directed weighted network, based on the number of times of effective impact;
determining an initial weight for each basic indicator, i.e., an initial weight for a node of the directed weighted network, based on a quantity of literatures associated with each basic indicator; and
inputting the initial weight for the edge and the initial weight for the node into the directed weighted network, and performing iterative calculation on a weight for each basic indicator based on a probability calculation formula.

Step 150: obtaining an observation value of each basic indicator based on the spatiotemporal raster database, determining an assessment value of a comprehensive indicator using the observation value of each basic indicator and the weight for each basic indicator to form an assessment indicator system for typical marine scenarios.

Specifically, after the weight for each basic indicator is obtained through the above steps, directional spatiotemporal extraction is performed by extracting the observation value of each basic indicator from the spatiotemporal raster database to obtain the observation value of each basic indicator within a limited spatiotemporal range. For example, a temperature observation value within a certain spatiotemporal range may be extracted, and an assessment value of the temperature indicator may be obtained based on the temperature observation value and an indicator weight of the temperature indicator to construct an assessment indicator system for typical marine scenarios.

In the method provided in the embodiment of the present disclosure, multi-source data associated with marine science are collected, processed and analyzed through a data preprocessing technology, and extracted using a knowledge extraction algorithm in combination with a large model, to construct a knowledge graph for typical marine scenarios, and establish a spatiotemporal raster database. A rich interactive relationship between indicators is obtained through the semantic association of the knowledge graph, and the existing initial indicator set is improved. The associated or causal relationship between the indicators based on the multimodal knowledge graph for typical marine scenarios is obtained, a process for calculating an indicator weight is modeled as a probability calculation problem based on a random walk graph network, and more objective and authoritative indicator weight is obtained through iterative calculation. Finally, in a specific actual calculation scenario, directed extraction is performed on the spatiotemporal raster data based on the knowledge graph to obtain indicator observation values, and the indicator network is quantified to provide support for subsequent research on marine science.

A device for constructing an assessment indicator system for typical marine scenarios based on a knowledge graph according to the present disclosure is described below, and the device for constructing the assessment indicator system for typical marine scenarios based on the knowledge graph described below and the method for constructing the assessment indicator system for typical marine scenarios based on the knowledge graph described above may be referenced to each other.

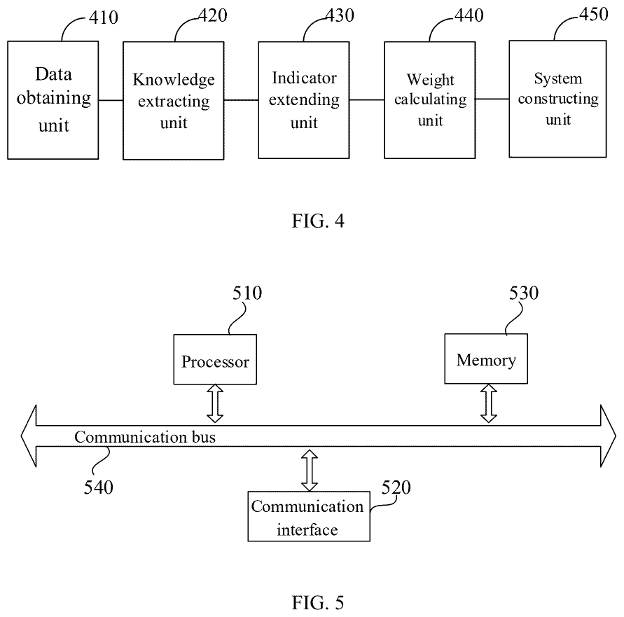

FIG. 4 is a schematic structural diagram of a device for constructing an assessment indicator system for typical marine scenarios based on a knowledge graph according to the present disclosure. As shown in FIG. 4, the device for constructing the assessment indicator system for typical marine scenarios includes:
a data obtaining unit 410, used for obtaining multi-source data associated with marine science and an initial indicator set;
a knowledge extracting unit 420, used for performing knowledge extraction on the multi-source data, and constructing a knowledge graph for typical marine scenarios and a spatiotemporal raster database based on a result of knowledge extraction;
an indicator extending unit 430, used for extending the initial indicator set based on the knowledge graph to obtain a basic indicator set, and obtaining a relationship between basic indicators and a degree of uncertainty of the relationship between the basic indicators;
a weight calculating unit 440, used for establishing a directed weighted network with indicators as nodes based on the relationship between the basic indicators and the degree of uncertainty of the relationship between the basic indicators, and calculating a weight for each basic indicator using a random walk model; and
a system constructing unit 450, used for obtaining an observation value of each basic indicator based on the spatiotemporal raster database, determining an assessment value of a comprehensive indicator using the observation value of each basic indicator and the weight for each basic indicator, and forming the assessment indicator system for typical marine scenarios.

The device provided by the embodiment of the present disclosure may construct an objective, comprehensive and highly versatile assessment indicator system. The assessment indicator system constructed in this way may be used to assess and predict the marine environment, provide support for subsequent research on marine science, and thus better protect the marine ecological environment.

Based on any one of the above embodiments, the indicator extending unit is used for:
extracting an initial indicator relationship between the basic indicators from the knowledge graph for typical marine scenarios; and
performing standardized transformation on the initial indicator relationship to obtain the relationship between the basic indicators and the degree of uncertainty of the relationship between the basic indicators.

Based on any one of the above embodiments, the weight calculating unit is used for:
obtaining an initial weight for each basic indicator as an initial weight for a node of the directed weighted network;
determining a number of times of effective impact between the basic indicators based on the relationship between the basic indicators and the degree of uncertainty of the relationship between the basic indicators, and determining the number of times of effective impact as an initial weight for an edge of the directed weighted network; and
performing iterative calculation on the initial weight for the node until convergence using the random walk model based on the initial weight for the node and the initial weight for the edge of the directed weighted network, to obtain the weight for each basic indicator.

Based on any one of the above embodiments, the weight calculating unit is used for:
performing iterative calculation on the initial weight for the node based on the following formula until convergence to obtain the weight for each basic indicator:

$$I ( x ) = \frac{1 - d}{N} + d {\sum }_{y ∈ R ( x )} I ( y ) \cdot {W}_{( x , y )}$$

$${W}_{( x , y )} = \frac{{n}_{( x , y )}}{N ( y )}$$

$${n}_{( x , y )} = AGG ( \{ {P}_{( x , y )}^{i} , i ∈ M \} )$$

$$N ( y ) = {\sum }_{z ∈ Z ( y )} AGG ( \{ {P}_{( z , y )}^{i} , i ∈ M \} )$$

where I(x), I(y) represent iterative indicator weight values of x and y indicators, respectively; d is a damping factor (0<d≤1), that is, a probability that any indicator is impacted by other indicators; N is a quantity of all basic indicators; R(x) represents a basic indicator set impacted by x indicator; n_{(x,y)} represents a number of times of effective impact of the x indicator on the y indicator, Z(y) represents a set of basic indicators that impact the y indicator, N(y) represents a total number of times of effective impact of all basic indicators on the y indicator, P_{(x,y)}ⁱ represents a quantized value of a degree of uncertainty of the relationship between the x indicator and the y indicator extracted from a literature i, and M represents a total quantity of literatures.

Based on any one of the above embodiments, the weight calculating unit is used for:
determining the initial weight for each basic indicator based on the quantity of literatures associated with each basic indicator.

Based on any one of the above embodiments, the knowledge extracting unit is used for:
performing knowledge extraction on the multi-source data based on a data type of the multi-source data and constructing the knowledge graph for typical marine scenarios based on N-tuple knowledge extracted, where N is a positive integer greater than or equal to 3; and
constructing the spatiotemporal raster database based on spatiotemporal raster data extracted from the multi-source data.

Based on any one of the above embodiments, the indicator extending unit is used for:
searching and matching an initial indicator entity in the knowledge graph, and returning an indicator having an associated or causal relationship with the initial indicator entity; and
supplementing the indicator having the associated or causal relationship to the initial indicator set to obtain the basic indicator set.

FIG. 5 is a schematic structural diagram of an electronic device. As shown in FIG. 5, the electronic device may include a processor 510, a communication interface 520, a memory 530, and a communication bus 540. The processor 510, the communication interface 520, and the memory 530 communicate with each other through the communication bus 540.

The processor 510 may call a logic instruction in the memory 530 to implement a method for constructing an assessment indicator system for typical marine scenarios based on a knowledge graph, the method including:
obtaining multi-source data associated with marine science and an initial indicator set;
performing knowledge extraction on the multi-source data, and constructing a knowledge graph for typical marine scenarios and a spatiotemporal raster database based on a result of knowledge extraction;
extending the initial indicator set based on the knowledge graph to obtain a basic indicator set, and obtaining a relationship between basic indicators and a degree of uncertainty of the relationship between the basic indicators;
establishing a directed weighted network with indicators as nodes based on the relationship between the basic indicators and the degree of uncertainty of the relationship between the basic indicators, and calculating a weight for each basic indicator using a random walk model; and
obtaining an observation value of each basic indicator based on the spatiotemporal raster database, determining an assessment value of a comprehensive indicator using the observation value of each basic indicator and the weight for each basic indicator to form an assessment indicator system for typical marine scenarios.

In addition, the logic instruction in the memory 530 described above may be implemented in the form of a software functional unit and may be stored in a computer readable storage medium while being sold or used as a separate product. Based on such understanding, the solution of the present disclosure, or the part of the solution, which is essential or makes contribution to the prior art, may be embodied in the form of a software product, and the software product is stored in a storage medium, includes several instructions for making a computer device (which may be a personal computer, server, or network device, etc.) perform all or part of the steps of the methods described in various embodiments of the present disclosure. The storage medium described above includes various media that may store program codes such as U disk, mobile hard disk, read-only memory (ROM), random access memory (RAM), magnetic disk, or optical disk.

The present disclosure further provides a computer program product, including: a computer program stored on a non-transitory computer readable storage medium, where when the computer program is executed by a processor, the processor implements the method for constructing the assessment indicator system for typical marine scenarios based on the knowledge graph described above. The method includes:
obtaining multi-source data associated with marine science and an initial indicator set;
performing knowledge extraction on the multi-source data, and constructing a knowledge graph for typical marine scenarios and a spatiotemporal raster database based on a result of knowledge extraction;
extending the initial indicator set based on the knowledge graph to obtain a basic indicator set, and obtaining a relationship between basic indicators and a degree of uncertainty of the relationship between the basic indicators;
establishing a directed weighted network with indicators as nodes based on the relationship between the basic indicators and the degree of uncertainty of the relationship between the basic indicators, and calculating a weight for each basic indicator using a random walk model; and
obtaining an observation value of each basic indicator based on the spatiotemporal raster database, determining an assessment value of a comprehensive indicator using the observation value of each basic indicator and the weight for each basic indicator to form an assessment indicator system for typical marine scenarios.

The present disclosure further provides a non-transitory computer-readable storage medium storing a computer program, where the computer program, when executed by a processor, implements the method for constructing the assessment indicator system for typical marine scenarios based on the knowledge graph as any one described above. The method includes:
obtaining multi-source data associated with marine science and an initial indicator set;
performing knowledge extraction on the multi-source data, and constructing a knowledge graph for typical marine scenarios and a spatiotemporal raster database based on a result of knowledge extraction;
extending the initial indicator set based on the knowledge graph to obtain a basic indicator set, and obtaining a relationship between basic indicators and a degree of uncertainty of the relationship between the basic indicators;
establishing a directed weighted network with indicators as nodes based on the relationship between the basic indicators and the degree of uncertainty of the relationship between the basic indicators, and calculating a weight for each basic indicator using a random walk model; and
obtaining an observation value of each basic indicator based on the spatiotemporal raster database, determining an assessment value of a comprehensive indicator using the observation value of each basic indicator and the weight for each basic indicator to form an assessment indicator system for typical marine scenarios.

The device embodiments described above are merely illustrative, where the units described as separate components may or may not be physically separate, and the components displayed as units may or may not be physical units, that is, they may be located at the same place or be distributed on multiple network units. Some or all of the modules may be selected according to actual needs to achieve the purpose of the solution of the present embodiment. Those skilled in the art may understand and implement the embodiments described above without paying creative labors.

Through the description of the embodiments above, those skilled in the art may clearly understand that the various embodiments may be implemented by means of software and a necessary general hardware platform, and of course, by hardware. Based on such understanding, the solutions of the present disclosure in essence or a part of the solutions that contributes to the prior art, or a part of the solutions, may be embodied in the form of a software product, which may be stored in a storage medium such as ROM/RAM, magnetic discs, compact discs, etc., and includes several instructions to cause a computer device (which may be a personal computer, server, or network device, etc.) to perform the methods described in various embodiments or a part thereof.

Finally, it should be noted that the above embodiments are only used to explain the solutions of the present disclosure, and are not limited thereto. Although the present disclosure is described in detail with reference to the foregoing embodiments, it should be understood by those skilled in the art that they may still modify the solutions described in the foregoing embodiments and make equivalent replacements to a part of the features and these modifications and substitutions do not depart from the scope of the solutions of the embodiments of the present disclosure.

What is claimed is:

1. A method for constructing an assessment indicator system for typical marine scenarios based on a knowledge graph, comprising:
obtaining multi-source data associated with marine science and an initial indicator set;
performing knowledge extraction on the multi-source data, and constructing a knowledge graph for typical marine scenarios and a spatiotemporal raster database based on a result of the knowledge extraction;
extending the initial indicator set based on the knowledge graph to obtain a basic indicator set, and obtaining a relationship between basic indicators and a degree of uncertainty of the relationship between the basic indicators;
establishing a directed weighted network with indicators as nodes based on the relationship between the basic indicators and the degree of uncertainty of the relationship between the basic indicators, and calculating a weight for each basic indicator using a random walk model; and
obtaining an observation value of each basic indicator based on the spatiotemporal raster database, determining an assessment value of a comprehensive indicator using the observation value of each basic indicator and the weight for each basic indicator to form an assessment indicator system for typical marine scenarios.

2. The method of claim 1, wherein obtaining the relationship between the basic indicators and the degree of uncertainty of the relationship between the basic indicators comprises:
extracting an initial indicator relationship between the basic indicators from the knowledge graph for typical marine scenarios; and
performing standardized transformation on the initial indicator relationship to obtain the relationship between the basic indicators and the degree of uncertainty of the relationship between the basic indicators.

3. The method of claim 2, wherein establishing the directed weighted network with indicators as nodes based on the relationship between the basic indicators and the degree of uncertainty of the relationship between the basic indicators, and calculating the weight for each basic indicator using the random walk model comprises:
obtaining an initial weight for each basic indicator as an initial weight for a node of the directed weighted network;
determining a number of times of effective impact between the basic indicators based on the relationship between the basic indicators and the degree of uncertainty of the relationship between the basic indicators, and determining the number of times of effective impact as an initial weight for an edge of the directed weighted network; and
performing iterative calculation on the initial weight for the node until convergence using the random walk model based on the initial weight for the node and the initial weight for the edge of the directed weighted network to obtain the weight for each basic indicator.

4. The method of claim 3, wherein performing iterative calculation on the initial weight for the node until convergence using the random walk model based on the initial weight for the node and the initial weight for the edge of the directed weighted network to obtain the weight for each basic indicator comprises:
performing iterative calculation on the initial weight for the node until convergence based on the following formula to obtain the weight for each basic indicator:
$$I ( x ) = \frac{1 - d}{N} + d {\sum }_{y ∈ R ( x )} I ( y ) \cdot {W}_{( x , y )}$$
$${W}_{( x , y )} = \frac{{n}_{( x , y )}}{N ( y )}$$
$${n}_{( x , y )} = AGG ( \{ {P}_{( x , y )}^{i} , i ∈ M \} )$$
$$N ( y ) = {\sum }_{z ∈ Z ( y )} AGG ( \{ {P}_{( z , y )}^{i} , i ∈ M \} )$$
wherein I(x), I(y) represent iterative indicator weight values of x and y indicators, respectively; d is a damping factor (0<d≤1), that is, a probability that any indicator is impacted by other indicators; N is a quantity of all basic indicators; R(x) represents a basic indicator set impacted by x indicator; n_{(x,y)} represents a number of times of effective impact of the x indicator on the y indicator, Z(y) represents a set of basic indicators that impact the y indicator, N(y) represents a total number of times of effective impact of all basic indicators on the y indicator, P_{(x,y)}ⁱ represents a quantized value of a degree of uncertainty of the relationship between the x indicator and the y indicator extracted from a literature i, and M represents a total quantity of literatures.

5. The method of claim 3, wherein obtaining the initial weight for each basic indicator comprises:
determining the initial weight for each basic indicator based on the quantity of literatures associated with each basic indicator.

6. The method of claim 1, wherein performing knowledge extraction on the multi-source data, and constructing the knowledge graph for typical marine scenarios and the spatiotemporal raster database based on the result of the knowledge extraction comprises:
performing knowledge extraction on the multi-source data based on a data type of the multi-source data, and constructing the knowledge graph for typical marine scenarios based on N-tuple knowledge extracted, where N is a positive integer greater than or equal to 3; and
constructing the spatiotemporal raster database based on spatiotemporal raster data extracted from the multi-source data.

7. The method of claim 1, wherein extending the initial indicator set based on the knowledge graph to obtain the basic indicator set comprises:
searching and matching an initial indicator entity in the knowledge graph, and returning an indicator having an associated or causal relationship with the initial indicator entity; and
supplementing the indicator having the associated or causal relationship to the initial indicator set to obtain the basic indicator set.

8. A device for constructing an assessment indicator system for typical marine scenarios based on knowledge graph, comprising:
a data obtaining unit, used for obtaining multi-source data associated with marine science and an initial indicator set;
a knowledge extracting unit, used for performing knowledge extraction on the multi-source data, and constructing a knowledge graph for typical marine scenarios and a spatiotemporal raster database based on a result of the knowledge extraction;
an indicator extending unit, used for extending the initial indicator set based on the knowledge graph to obtain a basic indicator set, and obtaining a relationship between basic indicators and a degree of uncertainty of the relationship between the basic indicators;
a weight calculating unit, used for establishing a directed weighted network with indicators as nodes based on the relationship between the basic indicators and the degree of uncertainty of the relationship between the basic indicators, and calculating a weight for each basic indicator using a random walk model; and
a system constructing unit, used for obtaining an observation value of each basic indicator based on the spatiotemporal raster database, determining an assessment value of a comprehensive indicator using the observation value of each basic indicator and the weight for each basic indicator, and forming an assessment indicator system for typical marine scenarios.

9. An electronic device comprising a memory, a processor, and a computer program stored on the memory and executable on the processor, wherein the processor, when executing the computer program, implements the method for constructing assessment indicator system for typical marine scenarios based on knowledge graph of claim 1.

10. A non-transitory computer-readable storage medium storing a computer program, wherein the computer program, when executed by a processor, implements the method for constructing assessment indicator system for typical marine scenarios based on knowledge graph of claim 1.
